(19) United States
(12) Patent Application Publication
(10) Pub. No.: US 2020/0024550 A1
(43) Pub. Date: Jan. 23, 2020

(54) CLEANING COMPOSITION

(71) Applicant: The Procter & Gamble Company, Cincinnati, OH (US)

(72) Inventors: Denis Alfred GONZALES, Brussels (BE); Jean-Luc Philippe BETTIOL, Etterbeek (BE)

(21) Appl. No.: 16/587,261

(22) Filed: Sep. 30, 2019

Related U.S. Application Data
(63) Continuation of application No. PCT/US2018/024497, filed on Mar. 27, 2018.

(30) Foreign Application Priority Data
Mar. 30, 2017 (EP) 17163855.4

(51) Int. Cl. C11D 3/22; C11D 11/00; C11D 1/94; C11D 3/00

(52) U.S. Cl. CPC C11D 3/226; C11D 11/0023; C11D 1/29; C11D 3/0094; C11D 1/94

(57) ABSTRACT

The present invention relates to a hand dishwashing cleaning composition including a surfactant system and from 0.1% to 10% by weight of the total composition of a cyclodextrin, wherein at least 50% or more of the cyclodextrin is complexed with the surfactant system. The invention also relates to use of the compositions for generation of flash suds in a hand dishwashing process.

### FIELD OF THE INVENTION

The present invention relates to a hand dishwashing cleaning composition comprising a surfactant system and a cyclodextrin, more in particular to a composition wherein at least 50% or more of the cyclodextrin is complexed to the surfactant system. The composition provides good sudsing profile, in particular flash suds (i.e., fast build-up of initial suds) and/or suds stabilization benefit. The composition also provides good cleaning of surfaces.

### BACKGROUND OF THE INVENTION

Traditionally, manual dishwashing is performed in a sink full of water with the cleaning composition diluted in it. Nowadays, some users prefer to wash one or small number of items under running water using a cleaning implement, preferably a sponge. The cleaning composition is dosed onto the dishware or alternatively the cleaning implement before or after the implement is wetted, a soiled item is then wiped, and subsequently rinsed under running water. The user usually relies on the sudsing profile as an indicator of the composition's cleaning ability. Accordingly, with this alternative way of hand dishwashing, sometimes referred to as “direct application”, the user requires that the cleaning composition will foam as soon as manual pressure is applied with or on the cleaning implement. The resultant rapid suds formation can be referred to as “flash suds”.

A particular challenge for formulating cleaning compositions comprising higher levels of surfactants towards having good flash suds is the stability of the surfactant aggregation that challenges the release of surfactant monomers to enable flash suds formation. When formulating surfactants above their critical micelle concentration they will order themselves in complex surfactant aggregate structures. These surfactant aggregate structures need to be broken up to enable surfactant monomers transferring to the air-water interface to start creating and stabilizing foam. Any delays with the breaking up action of the surfactant aggregates can delay the initial generation of suds. Similarly, delay in the required breaking up of surfactant aggregates can also result in a delay of cleaning on-set. As a result, the cleaning performance of the composition and/or the perception of the cleaning performance of the composition is negatively impacted during the initial phases of use. Previous attempts to improve flash suds and/or on-set of cleaning have not focused on the use of cyclodextrin to improve its generation.

Another challenge that the formulators must deal with is having to ensure that the cleaning compositions perform well under the new usage conditions. In particular, cleaning compositions that fail to exhibit sufficient suds stability and/or stabilization during the entire manual dishwashing operation, and not only during the initial phase, under the new usage conditions will not be viewed favourably by the users. For example, if the suds subside or the foam does not appear thick enough, then the users will assume that the cleaning composition remaining on the dishware or the cleaning implement does not still contain sufficient active ingredients. As a result, the users would have to re-dose the cleaning composition more frequently, which will likely result in consumer dissatisfaction with the performance of the cleaning composition.

Thus, the need remains for cleaning compositions having a good sudsing and/or cleaning profile, in particular good flash suds and/or suds stabilization benefit during use, particularly during the entire manual dishwashing operation. The need also exist for a cleaning composition, preferably a hand dishwashing cleaning composition, that provides good cleaning, in particular cleaning of soils and/or grease removal.

### SUMMARY OF THE INVENTION

In one aspect, the present invention is directed to a hand dishwashing cleaning composition comprising: (a) from 1% to 60%, preferably from 5% to 50%, more preferably from 8% to 40%, by weight of the composition of a surfactant system comprising: (i) an anionic surfactant; and (ii) a primary co-surfactant system, wherein the primary co-surfactant system is preferably selected from the group consisting of amphoteric surfactant, zwitterionic surfactant and mixtures thereof; and (b) from 0.1% to 10%, preferably from 0.5% to 4%, by weight of the total composition of a cyclodextrin, wherein at least 50% or more of the cyclodextrin is complexed with the surfactant system, and wherein the composition preferably comprises anionic surfactant and the primary co-surfactant system in a ratio of from 10:1 to 1:1. Preferably, the hand dishwashing cleaning composition as described herein above can be used for the generation of flash suds in a hand dishwashing process.

In another aspect, the present invention relates to use of: (a) a surfactant system; and (b) at least one cyclodextrin that is complexed with the surfactant system, in a hand dishwashing cleaning composition for the generation of flash suds in a hand dishwashing process. Preferably, the use as described herein above wherein the cyclodextrin is partially or fully complexed with the surfactant system. Preferably, the use as described herein above wherein at least 50% or more of the cyclodextrin is complexed with the surfactant system. Preferably, the surfactant system comprises: (i) at least one anionic surfactant selected from an ethoxylated C₈-C₁₈ alkyl ethoxy sulfate surfactant having an average ethoxylation degree of from 0.2 to 3, preferably from 0.4 to 1; and (ii) a co-surfactant system comprising at least one amine oxide surfactant, or at least one betaine surfactant, or at least one mixture of amine oxide and betaine surfactant. Preferably, the surfactant system comprises the anionic surfactant and the co-surfactant system in a ratio of from 10:1 to 1:1, preferably from 4:1 to 2:1.

In yet another aspect, the present invention relates to a method of manually washing dishware comprising: i) delivering a composition as described herein above onto the dishware or a cleaning implement; ii) cleaning the dishware with the composition in the presence of water; and iii) optionally, rinsing the dishware. Preferably, the composition of the present invention is used in neat form (i.e., direct application) since greater benefits in terms of grease cleaning are obtained when the composition is directly applied on the soiled surface or an a cleaning implement, such as a sponge, to be used to clean the soiled surface. The composition may also be used in diluted form (i.e., full sink) to manually wash dishware.

One aim of the present invention is to provide a hand dishwashing cleaning composition as described herein above which can exhibit good sudsing profile, in particular flash suds and/or suds stabilization benefit, preferably over the entire dishwashing process.

Another aim of the present invention is to provide such a composition as described herein above having good tough food cleaning (e.g., cooked-, baked- and burnt-on soils) and/or good grease cleaning.

A further aim of the present invention is to provide such a composition as described herein above wherein during use the suds is very appealing such that the suds are constituted by airy bubbles that seem to travel very quickly from the cleaning implement to the items to be cleaned. This is believed to contribute to a faster and better cleaning, especially under direct application of the composition on the dishware or cleaning implement.

Yet a further aim of the present invention is to provide such a composition as described herein above that neutralizes and/or masks malodours or reduce the perception by the user of the malodours. Preferably, the malodours are the disagreeable kitchen odours of food and/or cooking grease that can linger after the preparation and/or consumption of a meal.

Still yet a further aim of the present invention is to provide such a composition, comprising a cyclodextrin, as described herein above to reduce the viscosity of the composition and facilitate the reduction of viscosity trimming solvents in the formulation. Thus, it is an advantage of the invention to minimize capital costs and/or minimize energy costs.

These and other features, aspects and advantages of the present invention will become evident to those skilled in the art from the detailed description which follows.

### BRIEF DESCRIPTION OF THE DRAWINGS

While the specification concludes with claims particularly pointing out and distinctly claiming the invention, it is believed that the invention will be better understood from the following description of the accompanying FIGURE wherein:

FIG. 1 shows the flash suds generation profile upon dilution of a reference Composition E (comprising surfactant system and no complexed cyclodextrin) vs. Test Composition F of the present invention (comprising surfactant system complexed cyclodextrin).

### DETAILED DESCRIPTION OF THE INVENTION

### Definitions

As used herein, articles such as “a” and “an” when used in a claim, are understood to mean one or more of what is claimed or described.

The term “comprising” as used herein means that steps and ingredients other than those specifically mentioned can be added. This term encompasses the terms “consisting of” and “consisting essentially of.” The compositions of the present invention can comprise, consist of, and consist essentially of the essential elements and limitations of the invention described herein, as well as any of the additional or optional ingredients, components, steps, or limitations described herein.

The term “co-surfactant system” as used herein refers to one or more surfactants in a cleaning composition which is mainly used to improve the sudsing profile of a cleaning composition which already comprises a main surfactant, e.g. the surfactant present at the highest % by weight of the composition. The level of the co-surfactant system is typically less than 50%, or less than 40%, and typically more than 1%, or more than 5%, or more than 10%, or more than 20% by weight of the total amount of surfactants in the cleaning composition.

The term “dishware” as used herein includes cookware and tableware.

The term “flash suds” as used herein means the volume of initial suds generation upon dissolving of the cleaning composition on the dishware or the cleaning implement during the initial stages of the dishwashing process. The level of flash suds generation can be quantified by Test Method 2.

The terms “include”, “includes” and “including” are meant to be non-limiting.

The term “neat form” as used herein means that the composition is delivered onto the dishware or cleaning implement as it is, without previously diluting the composition with water.

The term “sudsing profile” as used herein refers to the properties of a cleaning composition relating to suds character during the dishwashing process. For example, the sudsing profile of a cleaning composition includes but is not limited to the flash suds generation upon dissolving of the cleaning composition, the volume and retention of the suds during the dishwashing cycle, and the ease of rinsing the suds away during the rinsing cycle.

It is understood that the test methods that are disclosed in the Test Methods Section of the present application must be used to determine the respective values of the parameters of Applicants' inventions as described and claimed herein.

In all embodiments of the present invention, all percentages are by weight of the total composition, as evident by the context, unless specifically stated otherwise. All ratios are weight ratios, unless specifically stated otherwise, and all measurements are made at 25° C., unless otherwise designated.

### Cleaning Composition

The inventors have surprisingly discovered a new way of formulating cleaning compositions to provide good sudsing profile, including flash suds and/or suds stabilization benefit. Essentially, the solution is to formulate the surfactant system in the presence of cyclodextrin, wherein at least 50% or more of the cyclodextrin is complexed with the surfactant system. In certain embodiments, the composition of the present invention will comprise cyclodextrin wherein at least 60% or more, or 70% or more, or 80% or more, of the cyclodextrin is complexed with the surfactant system. By the term “complexed”, it is meant that the cyclodextrin binds to one or several surfactants monomers, wherein one or several hydrophobic tail(s) of the surfactant penetrate the inner cavity of the cyclodextrin. In turn, the hydrophobic tail of the surfactant can thread into one or several cyclodextrin molecules.

In fact, the inventors have discovered that when the surfactant system complexes with the cyclodextrin, reduced effort is needed to generate initial suds with the cleaning composition. As a result, generation of flash suds is obtained. While not wishing to be bound by theory, it is believed that the cyclodextrin complexed surfactant system in the cleaning composition herein impacts the micellar aggregation such that more surfactant monomers are available to participate in generating initial suds and thus quickly-generated suds (i.e., flash suds) can be obtained. Preferably, the cyclodextrin complexed surfactant system in the cleaning composition herein may also afford high volume of the flash suds to be obtained.

In addition, the inventors have discovered that the cyclodextrin complexed surfactant system in the cleaning composition also provides enhanced suds stabilization. Without wishing to be bound by theory it is believed that the cycodextrin complexed surfactant system may more easily go to the air and water interface and remain in the suds film lamellae due to its specific physical properties, which is especially true for partially methylated cyclodextrin. As a result, the viscoelascity of the suds is increased and suds collapse due to the breakage of cyclodextrin complexed surfactant system is reduced and/or delayed. Therefore, enhanced suds stabilization of the cleaning composition of the present invention can also be obtained.

Specifically, in one aspect the present invention envisages a cleaning composition, preferably a hand dishwashing cleaning composition, comprising a surfactant system and a cyclodextrin complexed to the surfactant system, wherein at least 50% or more of the cyclodextrin is complexed to the surfactant system. The percentage complexation of the cyclodextrin to the surfactant system can be measured according to Test Method 1. The composition of the invention provides good grease removal, in particular good uncooked grease removal, especially under direct application conditions. The composition also provides good suds profile, including flash suds and/or suds stabilization benefit, preferably over the entire dishwashing process.

The composition is a hand dishwashing cleaning composition, preferably in liquid form. The composition contains from 30% to 95%, preferably from 40% to 90%, more preferably from 50% to 85% by weight of the total composition of a liquid carrier in which the other essential and optional components are dissolved, dispersed or suspended. One preferred component of the liquid carrier is water.

The pH of the composition is from about 5 to about 12, preferably from about 7 to about 10, or more preferably from about 8 to about 10, as measured at 25° C. and 10% aqueous concentration in distilled water. The pH of the composition can be adjusted using pH modifying ingredients known in the art.

The composition of the present invention can be Newtonian or non-Newtonian, preferably Newtonian. The composition has a viscosity of from 10 to 10000 mPa·s, preferably from 100 to 5000 mPa·s, more preferably from 300 to 2000 mPa·s, or most preferably from 500 to 1500 mPa·s. Viscosity is measured with a Brookfield RVT viscometer using spindle 21 at 20 RPM at 25° C.

### Cyclodextrin

The cleaning composition comprises a cyclodextrin. The composition comprises from 0.1% to 10%, preferably from 0.5% to 4%, by weight of the total composition of a cyclodextrin. As used herein, the term “cyclodextrin” includes any of the known cyclodextrins such as substituted and unsubstituted cyclodextrins containing from about six to about twelve glucose units, and mixtures thereof. Suitable non-limiting examples of “cyclodextrin” of the present invention can comprise cyclodextrin selected from the group consisting of α-cyclodextrin, β-cyclodextrin, γ-cyclodextrin, alkylated α-cyclodextrin, alkylated β-cyclodextrin, alkylated γ-cyclodextrin, hydroxyalkylated α-cyclodextrin, hydroxyalkylated β-cyclodextrin, hydroxyalkylated γ-cyclodextrin, methylated cyclodextrin and mixtures thereof, wherein the cyclodextrin is preferably β-cyclodextrin, hydroxypropylated β-cyclodextrin or methylated β-cyclodextrin and mixtures thereof. Preferably, the cyclodextrin is hydroxyalkylated cyclodextrin (HAC). Preferably, the composition is substantially free of maltitol hydroxy aliphatic ether (MHE).

### Surfactant System

The cleaning composition comprises from about 1% to about 60%, preferably from about 5% to about 50%, more preferably from about 8% to about 40%, by weight of the total composition of a surfactant system.

The surfactant system of the composition of the present invention comprises an anionic surfactant. Preferably, the surfactant system for the cleaning composition of the present invention comprises from 1% to 40%, preferably 6% to 35%, more preferably 8% to 30% by weight of the total composition of an anionic surfactant. The anionic surfactant can be any anionic cleaning surfactant, preferably selected from sulphate and/or sulfonate anionic surfactants. Especially preferred anionic surfactant is selected from the group consisting of alkyl sulfate, alkyl alkoxy sulfate and mixtures thereof, and preferably wherein the alkyl alkoxy sulfate is an alkyl ethoxy sulfate. Preferred anionic surfactant is a combination of alkyl sulfates and alkyl ethoxy sulfates with a combined average ethoxylation degree of less than 5, preferably less than 3, more preferably less than 2 and more than 0.5 and an average level of branching of from about 5% to about 40%, more preferably from about 10% to 35%, and even more preferably from about 20% to 30%. Suitable examples of commercially available sulfates include, those based on Neodol alcohols ex the Shell company, Lial-Isalchem and Safol ex the Sasol company, natural alcohols ex The Procter & Gamble Chemicals company. Suitable sulfonate surfactants for use herein include water-soluble salts of C8-C18 alkyl or hydroxyalkyl sulfonates; C11-C18 alkyl benzene sulfonates (LAS), modified alkylbenzene sulfonate (MLAS); methyl ester sulfonate (MES); and alpha-olefin sulfonate (AOS). Those also include the paraffin sulfonates may be monosulfonates and/or disulfonates, obtained by sulfonating paraffins of 10 to 20 carbon atoms. The sulfonate surfactant also include the alkyl glyceryl sulfonate surfactants.

The surfactant system of the composition of the present invention further comprises a primary co-surfactant system, wherein the primary co-surfactant system is preferably selected from the group consisting of amphoteric surfactant, zwitterionic surfactant and mixtures thereof. Preferably, the surfactant system for the cleaning composition of the present invention comprises from 0.5% to 15%, preferably from 1% to 12%, more preferably from 2% to 10%, by weight of the total composition of a primary co-surfactant system.

In certain embodiments, the primary co-surfactant system is an amphoteric surfactant. Preferably, the primary co-surfactant system is an amine oxide surfactant, and wherein the composition comprises anionic surfactant and amine oxide surfactant in a ratio of from 4:1 to 2:1, preferably from 3:1 to 2.5:1. Preferred amine oxides are alkyl dimethyl amine oxide or alkyl amido propyl dimethyl amine oxide, more preferably alkyl dimethyl amine oxide and especially coco dimethyl amino oxide. Amine oxide may have a linear or mid-branched alkyl moiety. Typical linear amine oxides include water-soluble amine oxides containing one R1 C8-18 alkyl moiety and 2 R2 and R3 moieties selected from the group consisting of C1-3 alkyl groups and C1-3 hydroxyalkyl groups. Preferably amine oxide is characterized by the formula R1-N(R2)(R3)O wherein R1 is a C8-18 alkyl and R2 and R3 are selected from the group consisting of methyl, ethyl, propyl, isopropyl, 2-hydroxyethyl, 2-hydroxypropyl and 3-hydroxypropyl. The linear amine oxide surfactants in particular may include linear C10-C18 alkyl dimethyl amine oxides and linear C8-C12 alkoxy ethyl dihydroxy ethyl amine oxides. Preferred amine oxides include linear C10, linear C10-C12, and linear C12-C14 alkyl dimethyl amine oxides. As used herein “mid-branched” means that the amine oxide has one alkyl moiety having n1 carbon atoms with one alkyl branch on the alkyl moiety having n2 carbon atoms. The alkyl branch is located on the a carbon from the nitrogen on the alkyl moiety. This type of branching for the amine oxide is also known in the art as an internal amine oxide. The total sum of n1 and n2 is from 10 to 24 carbon atoms, preferably from 12 to 20, and more preferably from 10 to 16. The number of carbon atoms for the one alkyl moiety (n1) should be approximately the same number of carbon atoms as the one alkyl branch (n2) such that the one alkyl moiety and the one alkyl branch are symmetric. As used herein “symmetric” means that |n1−n2| is less than or equal to 5, preferably 4, most preferably from 0 to 4 carbon atoms in at least 50 wt %, more preferably at least 75 wt % to 100 wt % of the mid-branched amine oxides for use herein. The amine oxide further comprises two moieties, independently selected from a C1-3 alkyl, a C1-3 hydroxyalkyl group, or a polyethylene oxide group containing an average of from about 1 to about 3 ethylene oxide groups. Preferably, the two moieties are selected from a C1-3 alkyl, more preferably both are selected as a C1 alkyl.

In an alternative embodiment the amine oxide surfactant is a mixture of amine oxides comprising a low-cut amine oxide and a mid-cut amine oxide. The amine oxide of the composition of the invention then comprises:
a) from about 10% to about 45% by weight of the amine oxide of low-cut amine oxide of formula R1R2R3AO wherein R1 and R2 are independently selected from hydrogen, C1-C4 alkyls or mixtures thereof, and R3 is selected from C10 alkyls or mixtures thereof; and
b) from 55% to 90% by weight of the amine oxide of mid-cut amine oxide of formula R4R5R6AO wherein R4 and R5 are independently selected from hydrogen, C1-C4 alkyls or mixtures thereof, and R6 is selected from C12-C16 alkyls or mixtures thereof

In a preferred low-cut amine oxide for use herein R3 is n-decyl. In another preferred low-cut amine oxide for use herein R1 and R2 are both methyl. In an especially preferred low-cut amine oxide for use herein R1 and R2 are both methyl and R3 is n-decyl.

Preferably, the amine oxide comprises less than about 5%, more preferably less than 3%, by weight of the amine oxide of an amine oxide of formula R7R8R9AO wherein R7 and R8 are selected from hydrogen, C1-C4 alkyls and mixtures thereof and wherein R9 is selected from C8 alkyls and mixtures thereof. Compositions comprising R7R8R9AO tend to be unstable and do not provide very suds mileage.

In certain embodiments, the primary co-surfactant system is a zwitterionic surfactant. Suitable examples of zwitterionic surfactants include betaines, such as alkyl betaines, alkylamidobetaine, amidazoliniumbetaine, sulfobetaine (INCI Sultaines) as well as the Phosphobetaine and preferably meets formula (I):

R1-[CO—X(CH2)n]x-N+(R2)(R3)-(CH2)m-[CH(OH)—CH2]y-Y— (I)

wherein
R1 is a saturated or unsaturated C6-22 alkyl residue, preferably C8-18 alkyl residue, in particular a saturated C10-16 alkyl residue, for example a saturated C12-14 alkyl residue;
X is NH, NR4 with C1-4 Alkyl residue R4, 0 or S;
n a number from 1 to 10, preferably 2 to 5, in particular 3;
x is 0 or 1, preferably 1;
R2, R3 are independently a C1-4 alkyl residue, potentially hydroxy substituted such as a hydroxyethyl, preferably a methyl;
m a number from 1 to 4, in particular 1, 2 or 3;
y 0 or 1; and
Y is COO, SO3, OPO(OR5)O or P(O)(OR5)O, whereby R5 is a hydrogen atom H or a C1-4 alkyl residue.

Preferred betaines are the alkyl betaines of the formula (Ia), the alkyl amido propyl betaine of the formula (Ib), the Sulfo betaines of the formula (Ic), and the Amido sulfobetaine of the formula (Id);

R1-N+(CH3)2-CH2COO— (Ia)

R1-CO—NH(CH2)3-N+(CH3)2-CH2COO— (Ib)

R1-N+(CH3)2-CH2CH(OH)CH2SO3- (Ic)

R1-CO—NH—(CH2)3-N+(CH3)2-CH2CH(OH)CH2SO3- (Id)
in which R11 as the same meaning as in formula I. Particularly preferred betaines are the Carbobetaine [wherein Y—=COO—], in particular the Carbobetaine of the formula (Ia) and (Ib), more preferred are the Alkylamidobetaine of the formula (Ib).

Examples of suitable betaines and sulfobetaine are the following [designated in accordance with INCI]: Almondamidopropyl of betaines, Apricotam idopropyl betaines, Avocadam idopropyl of betaines, Babassuam idopropyl of betaines, Behenam idopropyl betaines, Behenyl of betaines, betaines, Canolam idopropyl betaines, Capryl/Capram idopropyl betaines, Carnitine, Cetyl of betaines, Cocamidoethyl of betaines, Cocam idopropyl betaines, Cocam idopropyl Hydroxysultaine, Coco betaines, Coco Hydroxysultaine, Coco/Oleam idopropyl betaines, Coco Sultaine, Decyl of betaines, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl of PG-betaines, Erucam idopropyl Hydroxysultaine, Hydrogenated Tallow of betaines, Isostearam idopropyl betaines, Lauram idopropyl betaines, Lauryl of betaines, Lauryl Hydroxysultaine, Lauryl Sultaine, Milkam idopropyl betaines, Minkamidopropyl of betaines, Myristam idopropyl betaines, Myristyl of betaines, Oleam idopropyl betaines, Oleam idopropyl Hydroxysultaine, Oleyl of betaines, Olivamidopropyl of betaines, Palmam idopropyl betaines, Palm itam idopropyl betaines, Palmitoyl Carnitine, Palm Kernelam idopropyl betaines, Polytetrafluoroethylene Acetoxypropyl of betaines, Ricinoleam idopropyl betaines, Sesam idopropyl betaines, Soyam idopropyl betaines, Stearam idopropyl betaines, Stearyl of betaines, Tallowam idopropyl betaines, Tallowam idopropyl Hydroxysultaine, Tallow of betaines, Tallow Dihydroxyethyl of betaines, Undecylenam idopropyl betaines and Wheat Germam idopropyl betaines. A preferred betaine is, for example, Cocoamidopropylbetaine.

In certain embodiments, the surfactant system of the composition of the present invention further comprises from 0.1% to 10% by weight of the total composition of a secondary co-surfactant system preferably comprising a non-ionic surfactant. Suitable non-ionic surfactants include the condensation products of aliphatic alcohols with from 1 to 25 moles of ethylene oxide. The alkyl chain of the aliphatic alcohol can either be straight or branched, primary or secondary, and generally contains from 8 to 22 carbon atoms. Particularly preferred are the condensation products of alcohols having an alkyl group containing from 10 to 18 carbon atoms, preferably from 10 to 15 carbon atoms with from 2 to 18 moles, preferably 2 to 15, more preferably 5-12 of ethylene oxide per mole of alcohol. Highly preferred non-ionic surfactants are the condensation products of guerbet alcohols with from 2 to 18 moles, preferably 2 to 15, more preferably 5-12 of ethylene oxide per mole of alcohol. Preferably, the non-ionic surfactants are an alkyl ethoxylated surfactants, preferably comprising from 9 to 15 carbon atoms in its alkyl chain and from 5 to 12 units of ethylene oxide per mole of alcohol. Other suitable non-ionic surfactants for use herein include fatty alcohol polyglycol ethers, alkylpolyglucosides and fatty acid glucamides. Preferably, the composition comprises the anionic surfactant and the non-ionic surfactant in a ratio of from 2:1 to 50:1, preferably 2:1 to 10:1, or more preferably 2:1 to 3.5:1.

Preferably, the composition of the present invention comprises a surfactant system and cyclodextrin wherein the surfactant system is present in an effective amount to complex with the cyclodextrin to promote generation of flash suds, preferably wherein the percentage of the surfactant system is greater than 15% and preferably less than 60%, more preferably less than 40% or even more preferably less than 30% by weight of the total composition.

### Salt

The composition of the present invention may optionally comprise from 0.05% to 2%, preferably from 0.2% to 1.5%, or more preferably 0.5% to 1%, by weight of the total composition of a salt, preferably a monovalent, divalent inorganic salt or a mixture thereof, preferably sodium chloride.

### Hydrotrope

The composition of the present invention may optionally comprise from 1% to 10%, or preferably from 0.5% to 10%, more preferably from 1% to 6%, or most preferably from 0.1% to 3%, or combinations thereof, by weight of the total composition of a hydrotrope, preferably sodium cumene sulfonate. Other suitable hydrotropes for use herein include anionic-type hydrotropes, particularly sodium, potassium, and ammonium xylene sulfonate, sodium, potassium and ammonium toluene sulfonate, sodium potassium and ammonium cumene sulfonate, and mixtures thereof, as disclosed in U.S. Pat. No. 3,915,903. In one embodiment, the composition of the present invention is isotropic. An isotropic composition is distinguished from oil-in-water emulsions and lamellar phase compositions. Polarized light microscopy can assess whether the composition is isotropic. See e.g., The Aqueous Phase Behaviour of Surfactants, Robert Laughlin, Academic Press, 1994, pp. 538-542. In one embodiment, an isotropic composition is provided. In one embodiment, the composition comprises 0.1% to 3% by weight of the total composition of a hydrotrope, preferably wherein the hydrotrope is selected from sodium, potassium, and ammonium xylene sulfonate, sodium, potassium and ammonium toluene sulfonate, sodium potassium and ammonium cumene sulfonate, and mixtures thereof.

### Organic Solvent

The composition of the present invention may optionally comprise an organic solvent. Suitable organic solvents include C4-14 ethers and diethers, polyols, glycols, alkoxylated glycols, C6-C16 glycol ethers, alkoxylated aromatic alcohols, aromatic alcohols, aliphatic linear or branched alcohols, alkoxylated aliphatic linear or branched alcohols, alkoxylated C1-05 alcohols, C8-C14 alkyl and cycloalkyl hydrocarbons and halohydrocarbons, and mixtures thereof. Preferably the organic solvents include alcohols, glycols, and glycol ethers, alternatively alcohols and glycols. The composition comprises from 0% to less than 50%, preferably from 0.01% to 25%, more preferably from 0.1% to 10%, or most preferably from 0.5% to 5%, by weight of the total composition of an organic solvent, preferably an alcohol, more preferably an ethanol, a polyalkyleneglycol, more preferably polypropyleneglycol, and mixtures thereof.

### Amphiphilic Alkoxylated Polyalkyleneimine

The composition of the present invention may further comprise from 0.1% to 5%, preferably from 0.1% to 2%, more preferably from 0.3% to 1.5% by weight of the total composition of an amphiphilic alkoxylated polyalkyleneimine, preferably an amphiphilic polyethyleneimine polymer comprising a polyethyleneimine backbone having average molecular weight range from 100 to 5,000, preferably from 400 to 2,000, more preferably from 400 to 1,000 Daltons. Amphiphilic alkoxylated polyethyleneimine polymers will comprise ethoxy (EO) and/or propoxy (PO) and/or butoxy (BO) groups within their alkoxylation chains. When EO present, the amphiphilic alkoxylated polyethyleneimine will also comprise PO and/or BO groups. Preferred amphiphilic alkoxylated polyethyleneimine polymers comprise EO and PO groups within their alkoxylation chains, the PO groups preferably being in terminal position of the alkoxy chains, and the alkoxylation chains preferably being hydrogen capped.

Hydrophilic alkoxylated polyethyleneimine polymers solely comprising ethoxy (EO) units within the alkoxylation chain could also optionally be formulated within the scope of this invention.

The cleaning composition herein may comprise a number of optional ingredients such as builders, chelants, conditioning polymers, cleaning polymers, surface modifying polymers, soil flocculating polymers, structurants, emollients, humectants, skin rejuvenating actives, enzymes, carboxylic acids, scrubbing particles, bleach and bleach activators, perfumes, malodor control agents, pigments, dyes, opacifiers, beads, pearlescent particles, microcapsules, inorganic cations such as alkaline earth metals such as Ca/Mg-ions, antibacterial agents, preservatives, viscosity adjusters such as salt especially NaCl, and pH adjusters and buffering means.

The elements of the composition of the invention described in connexion with the first aspect of the invention apply mutatis mutandis to the other aspects of the invention.

### Method of Washing

In another aspect, the invention is directed to a method of manually washing dishware with the composition of the present invention. The method comprises the steps of: i) delivering a composition of the present invention onto the dishware or a cleaning implement; ii) cleaning the dishware with the composition in the presence of water; and iii) optionally, rinsing the dishware. The delivering step is preferably either directly onto the dishware surface or onto a cleaning implement, i.e., in a neat form. The cleaning device or implement is preferably wet before or after the composition is delivered to it. Especially good grease removal has been found when the composition is used in neat form. There is also provided a method of manually washing dishware in full sink wherein a volume of water is provided, the cleaning composition is delivered to the volume of water and the dishware is immersed therein.

In yet another aspect, provided is a use of: a) a surfactant system and b) at least one cyclodextrin, wherein at least 50% of the cyclodextrin is complexed with the surfactant system; in a hand dishwashing cleaning composition for the generation of flash suds in a hand dishwashing process. Preferably, the surfactant system comprises: i) at least one anionic surfactant selected from an ethoxylated C8-C18 alkyl ethoxy sulphate surfactant having an average ethoxylation degree of from 0.2 to 3, preferably from 0.4 to 1; and ii) a co-surfactant system comprising preferably at least one amide oxide surfactant, or at least one betaine surfactant, or at least one mixture of amine oxide and betaine surfactant, most preferably amine oxide. Preferably, the composition comprises the anionic surfactant and co-surfactant system in a ratio of from 10:1 to 1:1; preferably from 4:1 to 2:1.

In yet another aspect, provided is a use, in a hand dishwashing composition, comprising: a) a surfactant system comprising at least one anionic surfactant; and b) at least one cyclodextrin that is complexed with the surfactant system; for the generation of flash suds in a hand dishwashing process. Preferably, the use as described herein above wherein at least 50% of the cyclodextrin is complexed with the surfactant system.

Accordingly, further provided is a use, in a hand dishwashing composition, comprising: a) a surfactant system comprising at least one anionic surfactant; and b) at least one cyclodextrin, wherein at least 50% of the cyclodextrin is complexed with the surfactant system; for improving the stability of the suds of the composition.

### Test Methods

The following assays set forth must be used in order that the invention described and claimed herein may be more fully understood.

### Test Method 1: Measurement of Percentage of Cyclodextrin Complexation

This method measures the percentage of cyclodextrin complexed with the surfactant system for a composition. The measurement can be done by Nuclear Magnetic Resonance spectroscopy (NMR). The steps of the method are as follows:
1) Take the NMR spectra of the composition;
2) Identify the total cumulated intensity of the complexed cyclodextrin assigned shift peaks (note: these peaks are dependent on the cyclodextrin/surfactant types);
3) Identify the total cumulated intensity of all cyclodextrin (complexed+uncomplexed) assigned shift peaks; and
4) Express the relative ratio as a percentage (i.e., ratio*100), which equals the percentage of cyclodextrin complexation.

If formulating with multiple types of surfactants, then multiple types of cyclodextrin-surfactant complexes can form. Under such situations all cyclodextrin assigned signals related to each of the type of cyclodextrin complexes need to be accumulated to obtain the total cumulated intensity of the complexed cyclodextrin shift peaks. A skilled person in the art will know how to take and interpret such an NMR spectrum.

Test Method 2: Measurement of Flash Suds from Physical Agitation

This method measures flash suds in terms of the level of foam generated after an initial agitation of the test product. The steps of the method are as follows:
1. The finished product or test composition is diluted with 50% weight of water having 15° dh hardness at 25° C.;
2. 3 mL of 50% diluted test product is poured into a 40 mL graduated vial (diameter of 28 mm and height of 95 mm), preferably a graduated vial.
3. The vial is hand-shaken in an up and down motion over a distance of about 20 cm up and 20 cm down for 20 seconds at frequency of 120 shakes per minute at a 45 degree shake amplitude. One shake comprises one up and one down motion;
4. The vial is allowed to rest for 3 minutes at room temperature; and
5. The level of flash suds generated is measured in terms of the height of the foam generated in mm
   Test Method 3: Measurement of Flash Suds from Distribution in a Sponge

This method measures flash suds in terms of the level of foam generated after the test product is distributed on a cellulosic sponge. The steps of the method are as follows:
1. The finished product or test composition is diluted with water having 15° dh hardness at 25° C. to form compositions of varying concentrations (e.g., 90%, 80%, 70%, 60%, 50%, 40%, 30%, 20%, 10%, 5%, 1%, 0.5%, p.c.);
2. The diluted compositions are mixed with a magnetic stirrer until complete homogenization;
3. 30 g (±1 g) of a diluted composition is distributed homogenously on a cellulosic scrub sponge (available from Scotch-Brite™) which has been abundantly rinsed and dried until it contains no water;
4. The sponge is squeezed 10 times at a rate of 60 rpm, and the resultant suds are collected in a graduated cone; and
5. The suds is compressed gently with a spatula, and the final foam volume is measured after subtracting the liquid volume at the bottom of the cone.
6. The measurement is repeated for each diluted concentration.

### EXAMPLE

The following examples are provided to further illustrate the present invention and are not to be construed as limitations of the present invention, as many variations of the present invention are possible without departing from its spirit or scope.

### Example 1: Cyclodextrin-Surfactant Compositions Impact on Viscosity

Compositions B, C and D are examples of cleaning compositions according to the present invention, made with an aqueous surfactant matrix comprising 27.2% total surfactant comprising Alkyl(C12/C14)-0.6 ethoxylated sulphate and Alkyl(C12/C14)-dimethyl amine oxide in 3:1 weight % ratio, in the presence of varying amounts of a hydroxypropylated β-cyclodextrin (available as Cavasol® W7 from Wacker Chemie AG). Composition A is a reference composition containing the same surfactant matrix in the absence of a cyclodextrin. The compositions are summarized below in Table 1. The compositions are adjusted to pH 9 using NaOH/HCl to yield a gelled product and their viscosity are measured using a Brookfield Cylinder Viscometer (model no. SC10-10211-01) using 100 mL sample, a spindle 21, and a speed of 20 RPM.

TABLE 1

| | Comp. A | Comp. B | Comp. C | Comp. D |
|---|---|---|---|---|
| hydroxypropylated | 0% | 1% | 2% | 3% |
| β-cyclodextrin load in | | | | |
| 27.2% Surfactant Matrix | | | | |
| Viscosity (mPa · s) | >200,000 | 40,000 | 1,900 | 250 |

Table 1 shows the viscosity profile of a reference composition outside the scope of the invention not comprising the cyclodextrin and Compositions B to D inside the scope of the invention comprising a range of amounts of added cyclodextrin complexed to the surfactant system. The viscosity of the reference Composition A is in excess of 200,000 mPa·s. The high viscosity of the reference Composition A is the result of the formation of long-range entangled worm micelles. As shown by the results, the viscosity of Compositions B to D of the present invention drops upon addition of higher levels of the hydroxypropylated β-cyclodextrin as the incident of cyclodextrin/surfactant complex increases.

### Example 2: Cyclodextrin-Surfactant Compositions Impact on Flash Suds

Compositions F, G and H are examples of cleaning compositions according to the present invention, made with an aqueous surfactant matrix comprising 27.2% of a total surfactant system comprising Alkyl(C12/C14)-0.6 ethoxylated sulphate and Alkyl(C12/C14)-dimethyl amine oxide in 3:1 weight % ratio, in the presence of varying amounts of hydroxypropylated α-cyclodextrin. Compositions I to K are examples of cleaning compositions according to the present invention made with the same surfactant systems, in the presence of varying amounts of hydroxypropylated β-cyclodextrin. Composition E is a reference composition containing the same surfactant matrix in the absence of a cyclodextrin. The compositions are summarized below in Table 2. The compositions are diluted with 50% weight of water having 15° dh hardness at 25° C. 3 mL of the diluted composition is poured into a 40 mL graduated vial and the level of flash suds generated after physical agitation is measured according to Test Method 2. The results are summarized in Table 2.

TABLE 2

| | Comp. E | Comp. F | Comp. G | Comp. H | Comp. I | Comp. J | Comp. K |
|---|---|---|---|---|---|---|---|
| hydroxypropylated | 0% | 1% | 2% | 3% | — | — | — |
| α-cyclodextrin * | | | | | | | |
| loaded into 27.2% | | | | | | | |
| Surfactant Matrix | | | | | | | |
| hydroxypropylated | 0% | — | — | — | 1% | 2% | 3% |
| β-cyclodextrin ** | | | | | | | |
| loaded into 27.2% | | | | | | | |
| Surfactant Matrix | | | | | | | |
| Flash Suds | 10 mm | 17 mm | 19 mm | 34 mm | 15 mm | 30 mm | 38 mm |

* Cavasol ® W6 is available from Wacker Chemie AG.
** Cavasol ® W7 is available from Wacker Chemie AG.

Table 2 shows the flash suds generation performance of reference Composition E outside the scope of the invention not comprising cyclodextrin and of Compositions F to K comprising a range of cyclodextrin complexed to the surfactant system according to the present invention. It is clear from the data in Table 2 that an enhanced flash suds generation occurs in Compositions F to K comprising cyclodextrin complexed to the surfactant system.

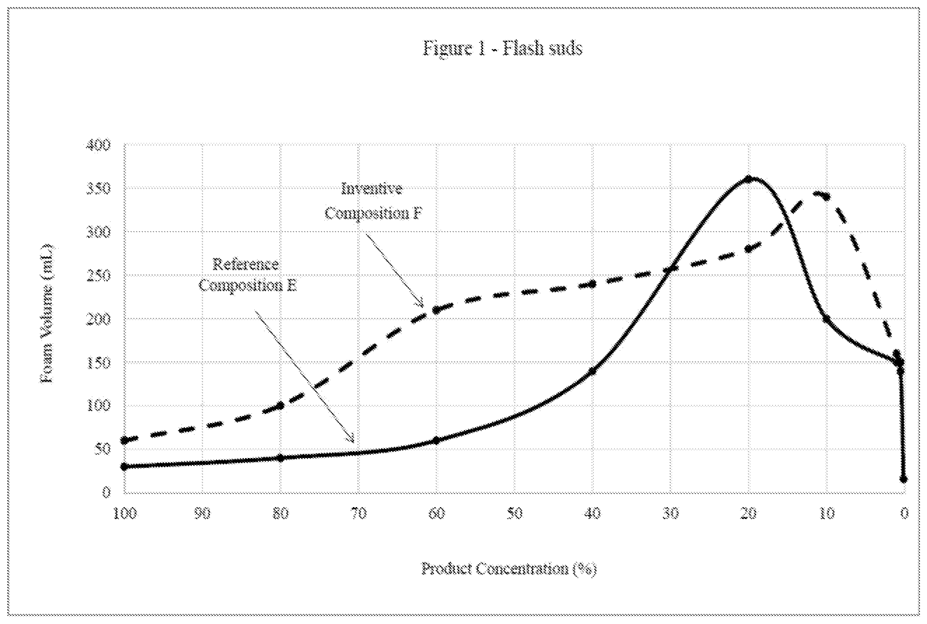

Composition F of the present invention (as disclosed in Table 2) which comprises 1% of the hydroxypropylated α-cyclodextrin complexed to the surfactant system, and reference Composition E, are diluted with water having 15° dh hardness at 25° C. at varying concentrations (e.g., 90%, 80%, 70%, 60%, 50%, 40%, 30%, 20%, 10%, 5%, 1%, 0.5%, p.c.). The level of flash suds generated after distribution of these diluted compositions on a cellulosic sponge is measured according to Test Method 3. The results are provided in FIG. 1.

FIG. 1 shows the flash suds generation of Composition F of the present invention (as disclosed in Table 2) which comprises 1% of the hydroxypropylated α-cyclodextrin complexed to the surfactant system. As shown by FIG. 1, the addition of the cyclodextrin enhances the generation of flash suds, particularly during the initial stages of the dishwashing process. Reference Composition E (as disclosed in Table 2), in the absence of the cyclodextrin, generates considerably less flash suds.

Compositions M and N are examples of cleaning compositions according to the present invention, made with an aqueous surfactant matrix comprising 27.2% of a total surfactant system comprising Alkyl(C12/C14)-0.6 ethoxylated sulphate and Alkyl(C12/C14)-dimethyl amine oxide in 3:1 weight % ratio, in the presence of varying amounts of methylated β-cyclodextrin. Composition L is a reference composition containing the same surfactant matrix in the absence of a cyclodextrin. The compositions are summarized below in Table 3. The compositions are diluted with 50% weight of water having 15° dh hardness at 25° C. 3 mL of the diluted composition is poured into a 40 mL graduated vial and the level of flash suds generated is measured according to Test Method 2. The results are summarized in Table 3.

TABLE 3

| | Comp. L | Comp. M | Comp. N |
|---|---|---|---|
| methylated β-cyclodextrin * | 0% | 1% | 2% |
| loaded into 27.2% | | | |
| Surfactant Matrix | | | |
| Flash Suds | 2 mm | 20 mm | 27 mm |

* Cavasol ® W7 M available from Wacker Chemie AG.

It is clear from the results in Table 3 that an enhanced flash suds generation occurs in Compositions M and N comprising cyclodextrin complexed to the surfactant system. Reference Composition L (as disclosed in Table 3), in the absence of the cyclodextrin, generates considerably less flash suds.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

What is claimed is:

1. A hand dishwashing cleaning composition comprising:
a) from about 1% to about 60% by weight of the total composition of a surfactant system comprising:
(i) an anionic surfactant; and
(ii) a primary co-surfactant system, wherein the primary co-surfactant system is selected from the group consisting of amphoteric surfactant, zwitterionic surfactant and mixtures thereof; and
b) from about 0.1% to about 10%, by weight of the total composition of a cyclodextrin, wherein at least about 50% or more of the cyclodextrin is complexed with the surfactant system; wherein the composition comprises anionic surfactant and the primary co-surfactant system in a ratio of from about 10:1 to about 1:1.

2. The composition according to claim 1, wherein the cyclodextrin is selected from the group consisting of α-cyclodextrin, β-cyclodextrin, γ-cyclodextrin, alkylated α-cyclodextrin, alkylated β-cyclodextrin, alkylated γ-cyclodextrin, hydroxyalkylated α-cyclodextrin, hydroxyalkylated β-cyclodextrin, hydroxyalkylated γ-cyclodextrin, methylated cyclodextrin and mixtures thereof.

3. The composition according to claim 2, wherein the cyclodextrin is β-cyclodextrin, hydroxypropylated β-cyclodextrin or methylated β-cyclodextrin.

4. The composition according to claim 1, wherein the cyclodextrin is hydroxyalkylated cyclodextrin (HAC), methylated cyclodextrin or mixtures thereof, and the composition is substantially free of maltitol hydroxy aliphatic ether (MHE).

5. The composition according to claim 1, wherein the anionic surfactant is selected from the group consisting of alkyl sulfate, alkyl alkoxy sulfate and mixtures thereof.

6. The composition according to claim 5, wherein the alkyl alkoxy sulfate is an alkyl ethoxy sulfate.

7. The composition according to claim 1, wherein the primary co-surfactant system is an amine oxide surfactant, wherein the composition comprises anionic surfactant and amine oxide surfactant in a ratio of from about 4:1 to about 2:1.

8. The composition according to claim 1, wherein the surfactant system of the composition further comprises from about 0.1% to about 10% by weight of the total composition of a secondary co-surfactant system comprising a non-ionic surfactant.

9. The composition according to claim 8, wherein the non-ionic surfactant is an alkyl ethoxylated surfactant comprising from about 9 to about 15 carbon atoms in its alkyl chain and from about 5 to about 12 units of ethylene oxide per mole of alcohol.

10. The composition according to claim 8, wherein the composition comprises the anionic surfactant and the non-ionic surfactant in a ratio of from about 2:1 to about 50:1.

11. The composition according to claim 1, wherein the surfactant system is present in an effective amount to complex with the cyclodextrin to generate increased flash suds relative to the surfactant system in the absence of complexed cyclodextrin.

12. The composition according to claim 11, wherein the percentage of the surfactant system is greater than about 15% by weight of the total composition.

13. The composition according to claim 1, wherein the composition may optionally comprise: from about 0.05% to about 2%, by weight of the total composition of a salt; from about 1% to about 10% by weight of the total composition of a hydrotrope; and from about 0.01% to about 25% by weight of the total composition of an organic solvent.

14. The composition according to claim 1, wherein the composition further comprises from about 0.1% to about 5%, by weight of the total composition of an amphiphilic alkoxylated polyalkyleneimine, wherein the amphiphilic alkoxylated polyalkyleneimine is an alkoxylated polyethyleneimine polymer comprising a polyethyleneimine backbone having average molecular weight range from about 100 to about 5,000 Daltons.

15. The composition according to claim 1, wherein the composition has a pH range of from about 5 to about 12 as measured at about 10% dilution in distilled water at about 20° C.

16. The composition according to claim 1, wherein the composition has a viscosity of from about 10 to about 10000 mPa·s as measured on a Brookfield RVT Viscometer using spindle 21 at about 20 RPM at about 25° C.

17. A method of manually washing dishware comprising:
i) delivering a composition according to claim 1 onto the dishware or a cleaning implement;
ii) cleaning the dishware with the composition in the presence of water; and
iii) optionally, rinsing the dishware.
